(19) United States
(12) Patent Application Publication
(10) Pub. No.: US 2013/0164190 A1
(43) Pub. Date: Jun. 27, 2013

(54) Sample Collection System with Integrated Drug Testing Apparatus

(71) Applicant: James Plante, Del Mar, CA (US)

(72) Inventor: James Plante, Del Mar, CA (US)

(21) Appl. No.: 13/333,144

(22) Filed: Dec. 21, 2011

(51) Int. Cl. G01N 21/75

(52) U.S. Cl. 422/401

(57) ABSTRACT

A urine sample collection and drug test kit includes a receiving vessel with a specially prepared mechanical holder. A prepared chemical test carrier insert is pushed into the holder to form a drug test system. The drug test kit additionally includes purpose functional cap integrated with the receiving vessel whereby a sure liquid tight seal is easily established by merely applying a pressure to the cap to complete a press fit seal between the cap and receiving vessel at their respective aperture peripheries. The carrier insert is fashioned to accommodate an array of drug test reagent strips, for example nitrocellulose strips having prescribed chemistry integrated thereon. Receiving vessels of these systems are particularly characterized in that they include a viewing window carefully aligned with respect to the mechanical holder whereby the carrier insert may be viewed as it is held indexed and fixed with respect to the exterior surface of the receiving vessel.

### BACKGROUND OF THE INVENTION

1. Field

The following invention disclosure is generally concerned with biomatter sample collection systems and specifically concerned with collection kits arranged for collection and two-stage testing of urine samples for multiple drug test panels.

2. Prior Art

Quick and reliable and inexpensive drug testing has now become commonplace in part because sophisticated drug test systems yield highly functional easy-to-use devices made of inexpensive materials.

In one important example, referred to as “easy split teacup” by its manufacturer, a urine sample collection device is provided as a two chamber compound system in which a first chamber of large volume receives and stores a sample of appreciable volume and a second chamber has therein a test card supporting chemistry for tests for a rally of drugs. Upon activation by a technician via a key insertion step, urine passes from the storage chamber to the test chamber where it reacts with prepared chemistry therein to produce a visual result. The system is rather complex as the device is difficult to manufacture, difficult to use and is expensive.

It is certainly preferable to avoid the two chamber system as this reduces costs. While the system does permit a technician to start the test at a time which is selected by him, a time which may be different than the time the specimen is provided, this advantage is not always useful. In many cases, it is a suitable procedure to initiate a chemical reaction without delay and expose the test reagents to the urine to be tested at the time the sample is provided. Where this is the case, it is preferable to do away with the two chamber keep system and provide a more simple test kit design and construction.

On the other side of the spectrum drug testing is sometimes done with a test kit provided as a simple planar card having held therein a plurality of test scripts (prepared chemistry). One of most popular version of this system is manufactured and sold under the Mark “Pro Spring”. These systems provide no means for receiving a sample. The instructions merely indicate “a sample is to be received in a clear container preferably class”. Into the collective urine, a technician tips the tip of the test strips where they pull urine into the strip via absorption or capillary action thus exposing the reagents to the urine and any drugs or drug metabolites there in that urine. The system is not preferred by users as it tends to be messy and difficult to use properly, albeit inexpensive.

Yet another system combines a collection vessel with a testing platform. A. “drug abuse cop” is provided with a screw top and thermometer. A drug test array is disposed and integrated with the vessels Element. When the cup is placed appropriately on its side, specially arranged standing legs are provided on the side of the container, urine collects the test strip in a manner suitable for necessary chemical reactions to occur. A technician can read results through a provided window or it just makes it unnecessary for the container to be reopened and greatly improves handling of unpleasant materials.

Inventors Hazard et al teach a urine specimen collection device in their U.S. Pat. No. 5,511,557 of Apr. 30, 1996. In this system, ergonomic cooperation between a user and the device includes an interface fashioned as a funnel having a tubular conduit to an enclosed container. While the simplicity may be useful, it is undesirable to have multi piece systems with waste elements to discard after use. Further, the containment vessel does not cooperate well with the drug test array cards convenient in the art.

In U.S. Pat. No. 5,881,596 by Tsuji et al, a urine sampling vessel is presented. The system is primarily designed about an elongated cylinder which operates to take samples of urine from receptacle containing same without cooperation means for receiving urine directly from the human body. Further, these arrangements do not cooperate well with array type test strip systems typical of drug testing apparatus.

In one nice example of a system arranged particularly with a view to cooperation with receiving samples directly from donors, South African inventors Venter and Venter propose devices which cooperate with a common toilet in U.S. Pat. No. 6,151,972. While having various useful qualities, these systems are not well suited for the objectives of modern common drug testing scenarios. Paasch et al of U.S. Pat. No. 7,011,634 offer similar contraptions.

In a far more modern system specifically designed for drug testing programs, inventors Ramsey et al put forth a two chamber system (mentioned above). The device has a key advantage in that exposure of urine to test reagents can be control in time and may be at a time different than the time when urine is received. However, the two chamber system is complex and somewhat difficult to use. It is also expensive and wasteful. it if formed of five separable parts including a screw cap, a gasket, a vessel a test card and cap. A user is required to deposit a sample and couple at least three of these via screw thread couplings. Thus, these are a bit inconvenient for some users.

A US patent titled: “Specimen Collection, Storage Transportation and Assaying Device” filed Aug. 3, 2004 is presented by Hartselle. This system similar to the one described immediately here prior includes a two chamber arrangement. A first chamber receives and stores urine and a second chamber includes a test or assay apparatus. These devices are made of many parts and are overly complex while offering much functionality which is not needed in most situations. Accordingly, the expense does not usually warrant any advantage afforded.

While systems and inventions of the art are designed to achieve particular goals and objectives, some of those being no less than remarkable, these inventions of the art have nevertheless include limitations which prevent uses in new ways now possible. Inventions of the art are not used and cannot be used to realize advantages and objectives of the teachings presented herefollowing.

### SUMMARY OF THE INVENTION

Comes now, James Plante with inventions of a sample collection systems including devices for receiving and testing urine for drugs and drug metabolites. It is a primary function of these sample collection and test systems to provide drug test kits which are easy to use by both donors and analysis technicians.

In a very special class of biomatter sample collection kits, means for testing are included as part of the container. A receiving volume into which a sample of biomatter, e.g. urine, is put also includes chemical testing apparatus therein. Chemical strips are exposed to received biomatter and a reaction take places between elements of the received biomatter and chemistry from which the test strip is comprised to produce a visual signal indicative of presence of substances under test. In one example, presence of certain drugs or drug related metabolites in urine will effect a color change at a test strip to indicate same and implicitly suggest drug use or abuse by the donor.

Accordingly, these sample collection and test kits are specifically arranged to receive urine samples and properly expose test strips thereto. Further, these kits include support for a plurality of drug tests as they are arranged about an array system and platform. The test platform which accommodates a plurality of drug test strips is inserted into a receiving vessel and is held fixed therein. Particularly, the test platform is held fixed behind a viewing window which operates to permit inspection of results from viewers outside the container without having to open same.

In some versions, a security system includes a shade or drape which prevents access to result except by authorized technicians. After a user deposits a sample into the container of the kit to initialize the drug test reaction, the user seals the container and conveys it to an authorized agent or technician for reading. In accordance with prescribed timelines, the authorized user receives the kit and removes the security drape therefrom to be afforded visual access to the test strips which may then be read.

Unlike systems of the art which require a container to be re-opened for insertion of a test apparatus, these containers have a test platform firmly contained therein whereby neither the sample donor nor the technician need to reopen the sealed container. Because the test platform is well aligned and affixed with respect to the viewing window, there is no need to reopen the container. Test results are visually read through the viewing window.

### OBJECTIVES OF THE INVENTION

It is a primary object of the invention to provide collection kits for receipt and testing of biological samples.

A better understanding can be had with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF THE DRAWING FIGURES

These and other features, aspects, and advantages of the present inventions will become better understood with regard to the following description, appended claims and drawings where:

FIG. 1 is perspective semi-exploded view of a collection and test kit of these systems;

FIG. 2 illustrates a sealing cap and a receiving vessel in coupled relation;

FIG. 3 is shows a test card having an array of test strip elements thereon in perspective;

FIG. 4 shows a test card being inserted into a receiving vessel and held via a mechanical interlock system;

FIG. 5 similarly shows another test card and alternative interlock system;

FIG. 6 shows a kit in perspective with a viewing window and security feature illustrated; and

FIG. 7 shows a similar kit in use.

### DETAILED DESCRIPTION OF THE INVENTION

Drug test kits of this invention are primarily comprised of three elements including a receiving vessel, a sealing cap, and a lest card. A test card element is inserted into an interior portion of the receiving vessel and affixed to and secured at its interior surface. In particular, the test card may be affixed to the receiving vessel such that it forms a prescribed spatial relationship with the receiving vessel and is held stationary in order to maintain that spatial relationship. More specifically the test card is held fixed and aligned with a viewing window of the receiving vessel whereby test strips may be visually inspected from the exterior of the receiving vessel.

### Receiving Vessel

These receiving vessels are further described as follows. Receiving vessels of these systems are preferably formed of molded plastic of a high quality which provides a smooth surface and good durability. An operative receiving vessel is made as a cup shaped container with an interior volume of sufficient quantity whereby a human test subject can conveniently and easily provide a urine sample. That is, the size of the container is ergonomically well fitted to cooperate with the function at hand, that is easy deposit of a urine sample therein. To facilitate this, a receiving vessel has a large aperture of about 10-30 square centimeters at its top, through which urine may be easily passed and in most cases directly from the donor's body while urinating naturally.

After a user deposits a sample of urine into the receiving vessel, it is desirable to seal the container securely and to prevent leakage. To facilitate this operation, a well-designed cap is provided which cooperates with the receiving vessel to form a tight seal. Because providing a urine sample is a process which may be accompanied by anxiety and awkwardness, it is best that a cap and vessel be integrated together in a fashion such that the cap is never completely separated from the vessel to avoid loss or misplacement. Accordingly, preferred versions have a cap which is molded together with a vessel from the same plastic where the cap and vessel are either in coupled or decoupled modes, but the cap and vessel are not separable from each other. This way, one doesn't struggle to find a lost cap at a moment when it is most inconvenient. As such, it is preferred that these sealing caps couple to cooperating vessel tops via a pressure fit rather than a threaded coupling as is commonly found in the art. Threaded couplings are more difficult to handle and use—for example they generally require two hands to engage. A press fit top may be easily coupled merely by pressing it to the receiving vessel with one hand.

### Viewing Window

These receiving vessels additionally have a viewing window through which visual inspections may be made. Once urine is deposited into the receiving vessel and the sealing cap has been tightly coupled to the top, it is preferable to not have to reopen the container. In most systems of the art, one risks spillage because a sample container is reopened prior to introducing a test element (test card). However, this invites problems as it exposes an operator to unpleasant biomatter and accompanying odors among others. Where a viewing window is provided, an authorized technician can look into the receiving vessel to read a test strip which has reacted with the urine. If a test strip is well positioned and held, and lies behind the window so, then it is an easy task for a view to read test results off test strips which have been properly exposed to the urine sample.

The viewing window may be formed of the same plastic from which the receiving vessel is molded and fabricated so long as it is sufficiently clear so as not to significantly obstruct the passing of light there through. Usually, it is preferable to form these windows of smooth polished plastic surfaces such that they do not interfere with natural imaging done with the eye in normal viewing without instruments. In most preferred versions, a significant area of the receiving vessel wall is allocated as a viewing window. These windows are preferably a few centimeters squared and generally up to about 10 centimeters square.

The viewing window is cooperatively coupled to both a security drape and a test card. A security drape on arranged at the exterior surface of the viewing window is aligned such that the view to the inside of the receiving vessel is blocked such that the test card cannot be seen. When the kit is passed to those authorized to view the test results, the security drape is easily removed to permit viewing through the window.

The viewing window is additionally spatially coupled to the test card. The test card is held in position inside the receiving vessel whereby it is well aligned with the window to permit viewing of all relevant parts of the test card, i.e. the test strips. A viewer can look through the window to see the test strips as the test card is held fast behind the window and does not move about freely in the receiving vessel.

Receiving vessels of these systems also include an important functional element at their interior. Preferably molded directly into the same plastic from which the receiving vessel is made, is an index system which forms a containment space and mechanical interlock to hold the test card.

### Index at Interior

These receiving vessels also include an index system inside the vessel at the surface. An index system is designed with respect to the location and positioning of the viewing window whereby a test card or test card and carrier inserted and coupled via the index is held firmly in place with respect to the viewing window whereby the test card may be examined through the window. An index forms a confinement space or ‘trap’ into which suitably shaped test card or carriers will fit and cooperate. It is a primary objective of these indices to hold the test card before the window and to prevent the test card from moving about within the receiving vessel.

### Pressure Fit Seal

The receiving vessel additionally includes a first portion of a pressure fit liquid tight seal. A complementary and operating second portion of this press fit seal is integrated as part of the sealing cap. When the sealing cap is pushed into place a top that receiving vessel, the cap and vessel together operate to form an enclosed space to reliably seal liquids therein and prevent leakage. Another important element of the receiving vessel is a mechanical interlock system which receives a test card or test card and carrier combination and holds these fixed in position. Mechanical interlocks of these systems may be also integrated with the receiving vessel by way of multi-area plastic shaped features at the interior surface of the receiving vessels operate to interact with an inserted test card and/or carrier. The mechanical interlock is disposed, a lined and positioned with respect to the viewing window. A test card or carrier properly inserted into and coupled with a mechanical interlock of these systems is prevented from moving laterally or circumferential we about the receiving vessel accidents. In some versions, the mechanical interlock additionally of fixes a test card or carrier such that it cannot be removed through the top and semi-permanently fixes the card or carrier to the interior surface of the receiving vessel.

### Test Card

A test card is arranged to carry an array plurality of test strip elements each spatially removed from others in an arrangement. In some versions, a test card is combined with a carrier element to form a single unit which may be locked into place in the receiving vessel by the aforementioned mechanical interlock system.

A test card is prepared to carry a plurality of nitrocellulose test strips pre-impregnated with test reagents responsive to the presence of drugs and drug metabolites which may be found in urine. A test card is preferably arranged as a set of transparent plastic sleeves in a ‘1×N’ array each aligned one next to at least one other. In some versions, a sleeve of a test card which accommodates a single test strip is provided such that an end of a test strip slightly protrudes from the sleeve to improve exposure to urine. In particular, it is useful to expose the test strip ends at the bottom of the receiving vessel. At the same time, it is desirable to protect the other ends (at top of system) of the test strips from exposure. Accordingly, preferred versions of sleeves of these test cards are prepared with their top ends sealed. A test card may be made on a flexible plastic planar substrate having thereon a plurality of sleeves. The top of the sleeves may be sealed whereby liquid cannot pass into the sleeve at the top side.

The edges of the test card may be shaped to engage and cooperate with the mechanical index of the interior surface of the receiving vessel. A test card is fashioned about a substrate—sometimes a flexible substrate having a spring nature—and the edges of the substrate are shaped and sized whereby they will easily couple with the index such that a test card is held in position with respect to the viewing window of the receiving vessel.

Test Card with Carrier

In some special alternative versions, a compound carrier substrate is fashioned in two portions. These two portions include a first portion being a subcarrier card and a second portion being a main carrier having a slotted receiving station. For ease of fitting membrane stripes into prescribed receiving sleeves of a subcarrier card of thin flexible plastic material, the subcarrier card includes sleeves which are complementary in size into which the membrane strips may be easily inserted. After a plurality of membrane strips are inserted into their appropriate assigned sleeves, the entire subcarrier card is joined with the main carrier. The subcarrier card is then fitted and received at the main carrier device in a slotted receiving station to form the compound carrier substrate.

In systems where a test card is combined with a carrier, the edges of the carrier are shaped to cooperate with the mechanical index of the interior surface of the receiving vessel. A carrier device is sometimes formed in shape and size quite complementary with respect to the interior of the receiving vessel to provide better cooperation therewith. Both is position and holding properties and also with respect to control the manner in which urine may be absorbed by the tips of the test strips. In some cases, the carrier is polished on surfaces which touch the receiving vessel to control passage of urine in a manner where preferred absorption characteristics and control may be achieved. As such, the index of the receiving vessel interacts with the carrier rather that the test card directly, but the function remains the same—to hold the test card (albeit via the carrier) in position with respect to the viewing window.

### Membrane Strips

Chemical reaction testing is done on test strips having prepared reagents thereon. These are arranged in a fashion whereby each discrete reagent or test pad is spatially removed from the others. A reaction result produces visually detectable indicia. In one important version, the presence of a target drug in urine prevents a control reaction and a colored line fails to appear where it would otherwise appear in clean urine or urine free from drugs.

In some versions of these systems, it is desirable to test for a plurality of drugs. In these cases, one preferred arrangement includes a separate test strip for each drug under test. Accordingly, an array of test strips are provided one strip each next to another to form a one-to-one correspondence between drugs tested and strips of the kit. Where several strips are to be used in a multiple drug panel kit, each test strip may be arranged adjacent to the others in a card having thereon sleeve into which the test strips may be inserted

Some versions of these drug tests rely on competitive immunochemical reactions between a drug-protein conjugate or labeled drug and the drug or drug metabolites are present in urine samples collected from test subjects. These tests may contain membrane strips of nitrocellulose having integrated therewith drug-protein conjugates or antibodies in a test region and a pad containing colored antibody or drug-protein—colloidal gold conjugate.

In testing, a urine sample absorbed at a test strip tip near the bottom of a sample container migrates toward and dehydrates the antibody or drug protein-colloid conjugate. The mixture then migrates along the membrane by capillary action to the immobilized drug-protein or antibody band on the test region. When the tested drug or drug metabolite is absent in the urine, the colored antibody (or drug-protein)-colloidal gold conjugate and immobilized drug-protein or antibody bind specifically to form a visible line in the test region as the antibody complexes with the drug-protein.

Where the urine sample contains a sufficient quantity of the drug under test (or its associated metabolite) the drug or metabolite will compete with drug-protein with regard to binding at the limited number of antibody sites. The test region color will become less intense for cases wherein there is sufficient drug concentration. Where a large quantity of the drug is present in the urine sample, the drug will entirely prevent attachment of the colored antibody (or drug-protein)-colloidal gold conjugate to the drug-protein or antibody on the test region. Accordingly, presence of a line at the test region yields a negative result for the drug. Conversely, absence of a colored test line on the test region indicates a positive result or the presence of the test drug in urine.

To assure accuracy and proper functionality, these tests also include a control region on the same membrane strip. Control reagents are included at a control pad adjacent to the test pad. A visible line generated by a different antigen/antibody reaction should also appear at the control region of the test strip where proper reaction environment exists. The control line should appear in all valid tests as it indicates proper conditions for chemical response of the test strip. As such, a negative urine sample will produce both test line and control line, and a positive urine sample will generate only the control line.

### Sealing Cap

A sealing cap is a single piece molded plastic cap with an interior surface and exterior surface which mates with the receiving vessel via the pressure fit seal. Because the size and shape of the sealing cap is well formed to cooperate with the receiving vessel and both are made of high quality plastic a secure leak-proof and liquid tight seal is effected whenever the cap is pushed to and mated with the receiving vessel. At the exterior surface on the top, a sealing cap may additionally support application of indicia which may be useful in aiding handling and identification tasks associated with use of these systems.

Because of the nature of contents to be contained by these collection kits, it is desirable to provide a most secure coupling between the sealing cap and receiving vessel when these are in a coupled state. Accordingly, a visual system which assures proper and complete sealing may also be included.

### Hinge

The sealing cap may be permanently coupled to the receiving vessel by a hinge. The hinge is arranged to cause the cap to come to the receiving vessel top at an angle and approach which encourages the press fit seal to be securely made as a user gently pushes the cap onto the receiving vessel. In best versions, the cap, vessel and hinge are all molded together as one part in a compound mold apparatus. Because the hinge maintains that the sealing cap is inseparable from the receiving vessel, a user is never faced with the possibility of losing or misplacing the cap. In addition, a screw cap requires two hands to couple with its mate, while the press fit caps described herein are easily operable with a single hand which often is a useful advantage for those providing urine samples.

### PREFERRED EMBODIMENTS OF THE INVENTION

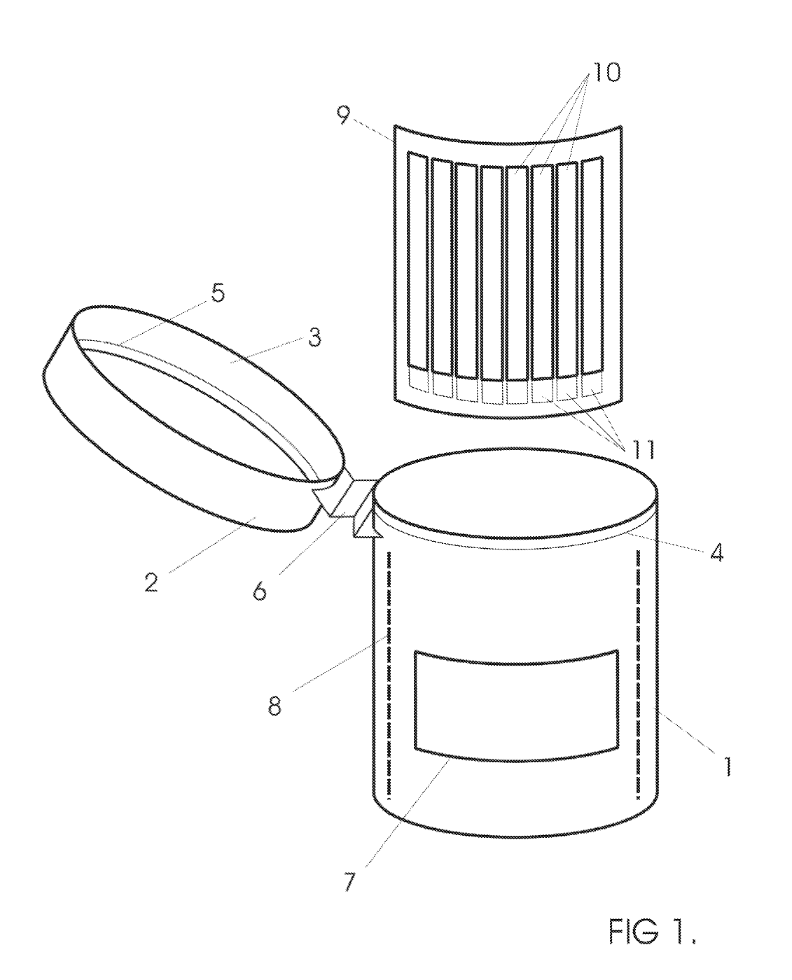

A greater understanding of each of these elements is realized in view of the drawing figures appended hereto and reference numerals therein. In particular with reference to FIG. 1, receiving vessel I is illustrated in proximity to sealing cap 2, the receiving vessel and sealing cap are shown in a ‘decoupled’ mold whereby access to the interior of the receiving vessel is afforded. The shape of the interior surface 3 of the sealing cap is formed to engage and cooperate with an annular rim 4 at the top of the receiving vessel. In particular, a ridge or ‘lip’ seats with a complementary shaped cooperating ridge 5 impressed into the interior surface of the sealing cap. The cap and vessel formed as a single molded system are easily joined into a coupled mode when the cap is pushed onto the vessel and pressure causes the lip seat of the cap to engage the annular rim of the receiving vessel to form a liquid tight press fit seal.

The cap and vessel may be formed with an integrated hinge 6. The hinge operates to prevent the cap from being separated from the receiving vessel while additionally supporting two operational modes including a coupled and decoupled mode. When the system is open or ‘decoupled’, a person under test may easily deposit urine into the container. Immediately thereafter, the container may be securely closed by merely pushing the cap to the top of the receiving vessel; this may be easily done with one hand.

Into the material from which the receiving vessel is formed, a viewing window 7 is included as shown. A technician or examiner is able to view test strips (inside the receiving vessel) through the window after prepared reagents of the test strips have been properly exposed to urine under test. Because the plastic is a high quality dense material, it is readily made transparent to facilitate viewing as described. In some versions, both the interior and exterior surfaces of the window might be polished to improve visibility. While a window may have some variance in both shape and size, one arrangement which works particularly well includes an elongated or rectangular shape of about 10 centimeters square. Such size and arrangement is important because it cooperates with the security window, the side of the receiving vessel, the nature of the array of test strips, and the test card system. Of course, one will appreciate that some variance in the viewing window size and shape will be possible without deviating from its intended functions and cooperation with other system elements.

### Mechanical Interlock

A mechanical interlock 8 may be arranged to couple with the edges of the test card 9 to the interior surface of the receiving vessel at its side wall(s). In one important version, the interior surface of the receiving vessel is prepared with slots or rails 8 which cooperate with the sides of a test card to hold it in place within the receiving vessel. A test card is prepared with test strips 10 whereby the tips 11 of those test strips are exposed from the sleeve and then the test card is inserted into the receiving vessel at the mechanical interlock which confines and holds the test card in relation to the window such that it may be readily viewed.

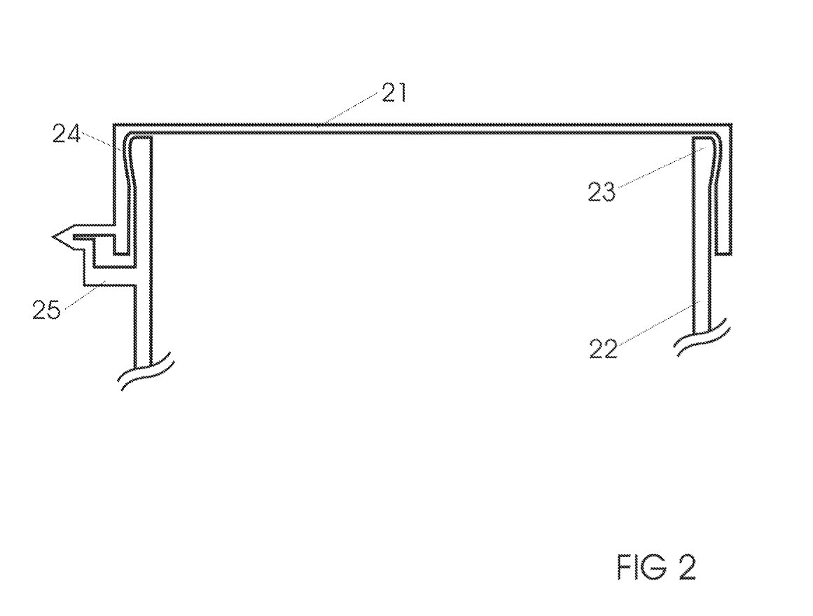

FIG. 2 illustrates in cross-section one preferred coupling between a sealing cap 21 and a receiving vessel 22. While the illustration of FIG. 1 shows the system in a decoupled mode, the illustration of FIG. 2 shows the cap and vessel in a coupled mode. The top rim 23 of the receiving vessel forms a ridge which fits tightly into a recess 24 formed in the sealing cap. The sealing cap, hinge, and vessel may be formed as a single integrated system via molded plastics. This is particularly beneficial for instant systems which are accompanied by difficulty of use. Where systems of the art having multiple separable elements are used, these generally suffer from greater difficulty of use.

In some versions, the top rim 23 of the receiving vessel is dyed with a translucent color. Similarly, the recess region of the sealing cap may also be dyed, in this case with a cooperating color—for example a different primary color. In this way, when the coupling is made between the sealing cap and the receiving vessel the two colors operate together to make a uniform third color providing visual indication the coupling is complete. Any inhomogeneity in the color band formed by the two elements indicates an incomplete seal. Accordingly, some versions of these systems include such visual indications of proper seal between a cap and vessel.

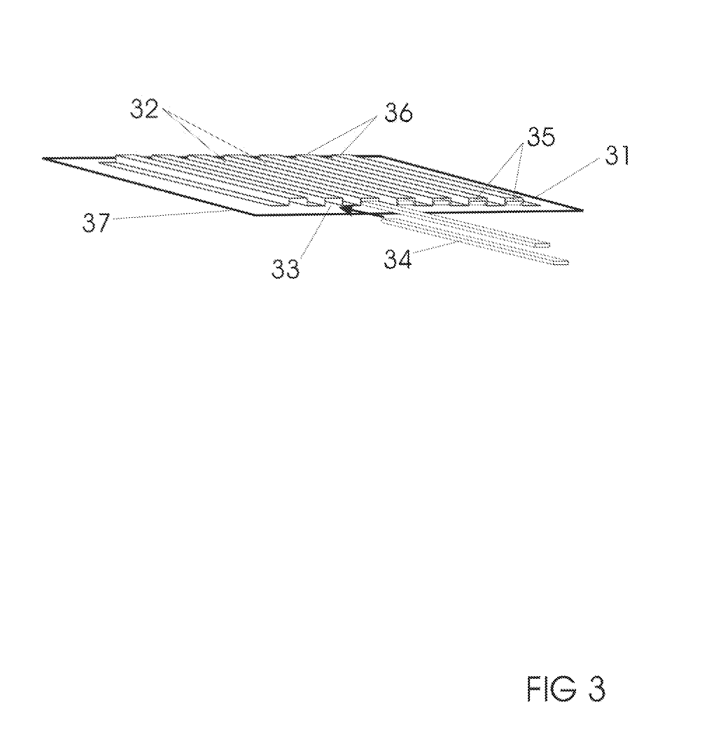

FIG. 3 shows a test card formed on a flexible transparent planar element to form a receiver of test strips in an array arrangement. A plurality of sleeves are closed on one end 32 and open on the opposing end 33. Nitrocellulose (or similar alternative) test strips 34 may be inserted into the sleeves so arranged. The test strip tips 35 are left exposed such that they can absorb urine from a sample in which the test card may come into contact. As the top ends of the sleeves are sealed, urine cannot enter the sleeves there and the test strips are protected against exposure from the top end.

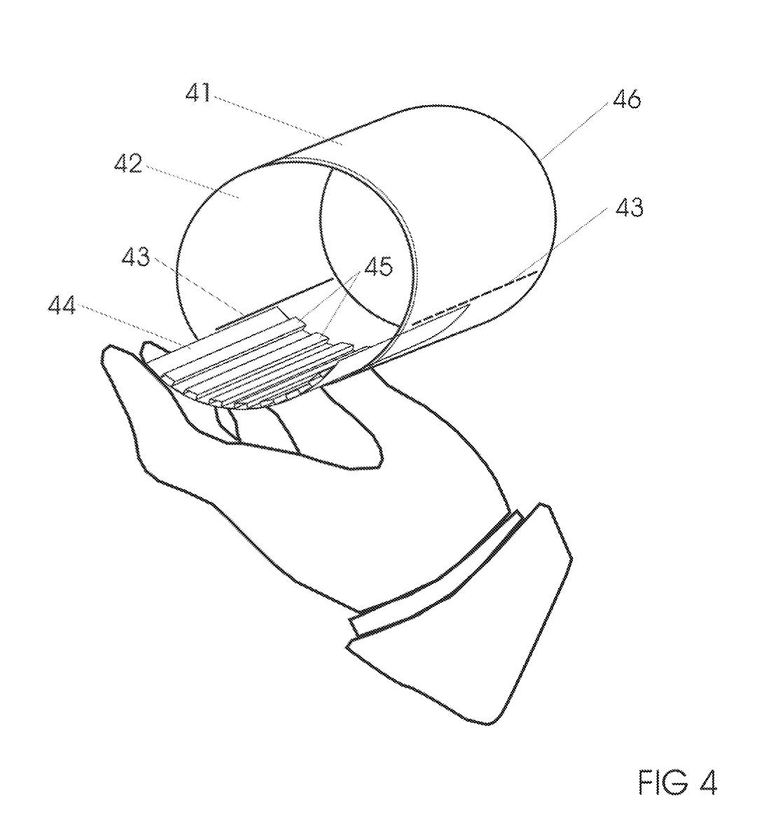

FIG. 4 illustrates a receiving vessel 41 having an interior surface 42 with molded mechanical interlock 43. In this case the mechanical interlock may be embodied as molded ‘slots’ or ‘rails’—a linear system running appreciably from the top to bottom of the interior surface of the receiving vessel to form and define a confinement space. Pressure applied to the edges of the test card bends it into a curve shape matching interior surface of the receiving vessel. The test card 44 having a natural spring, tries to regain its planar shape and puts pressure on the rails thus holding the test card in the receiving vessel by way of mechanical interlock. The ends 45 of the test card sleeves lie at the bottom of the receiving vessel with the test strip tips exposed there. The mechanical interlock may be such that the test card cannot easily be withdrawn without seriously deforming test card. In one example, the top edge of the test card meets clip, detent or latch which firmly holds and prevents the top of the test card from being released.

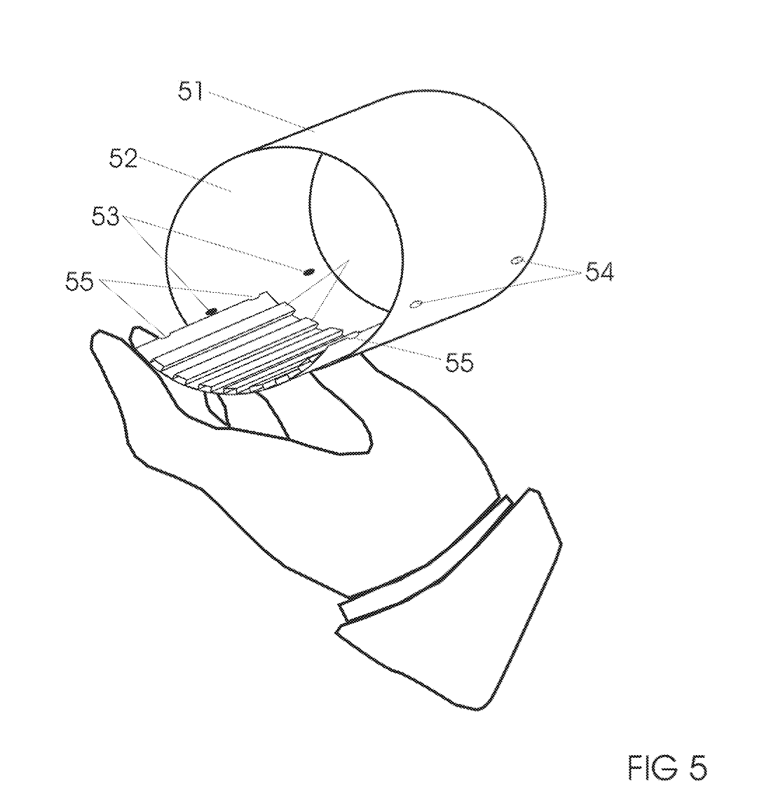

In another example of a mechanical interlock system which locates the test card spatially with respect to the viewing window and simultaneously prevents the test card from being withdrawn from the receiving vessel, FIG. 5 shows receiving vessel 51 having an interior surface 52. Mechanical ‘nubs’ 53 and 54 are mere bumps of plastic well-placed and formed on the interior surface of the receiving vessel. Cooperating mechanical features formed in the test card, in the present example indents 55 will line up and engage the nubs to cause the test card to align properly with respect to the receiving vessel and the viewing window therein. Of course, the precise shape of the mechanical interlock may be highly variable without loss functionality. Various implementations of mechanical interlocks will accomplish the same or similar result of locating holding the test card with respect to the viewing window.

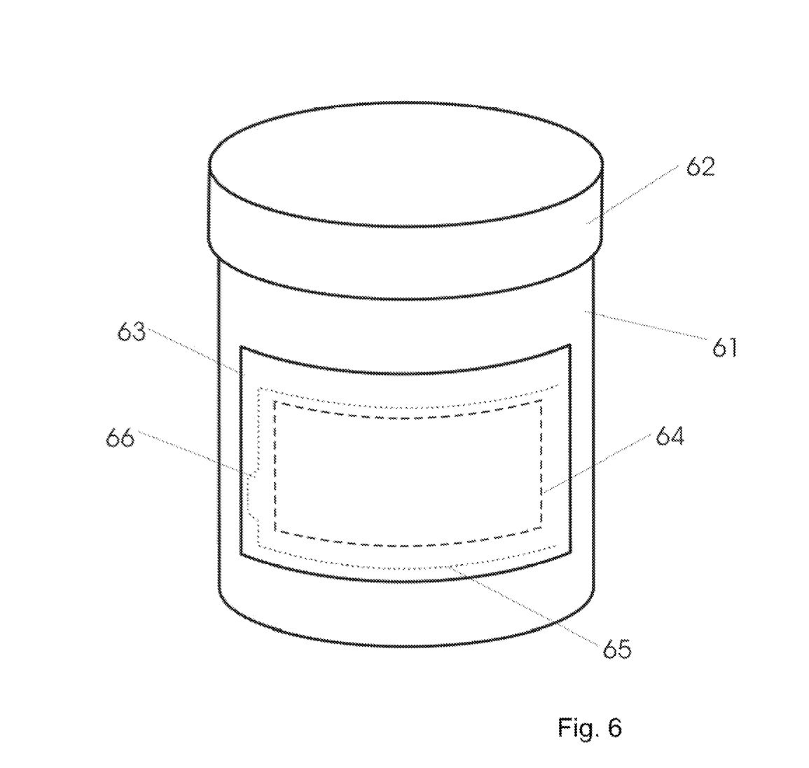

Another important feature of these systems relates to a security function which is desirable with some drug testing programs. An opaque security drape or cover is provided over the window to prevent unauthorized viewing of the test results. From the time a test subject provides urine until the time an authorized viewer or technician is in private possession, it is sometimes preferable to maintain test result secrecy. For this reason and opaque security drape covers the viewing window. The drape is arranged to affix to the external surface of the receiving vessel by way of a permanently destructive coupling. Once the drape is separated from the receiving vessel, it cannot be replaced. When possession of the drug kit has transferred from the donor to the authorized test technician, the drape may be easily removed by peeling away from the receiving vessel. A more complete understanding is realized in view of the drawing figure FIG. 6. Receiving vessel 61 has sealing cap 62 tightly sealed thereon. A security drape 63 is fastened to the external surface of the receiving vessel for example by strong adhesives. The security drape covers the viewing window 64 and test strips lying thereunder cannot be seen by those having access to the container. The security drape includes a perforated path 65 to define a flap with a pull tab 66.

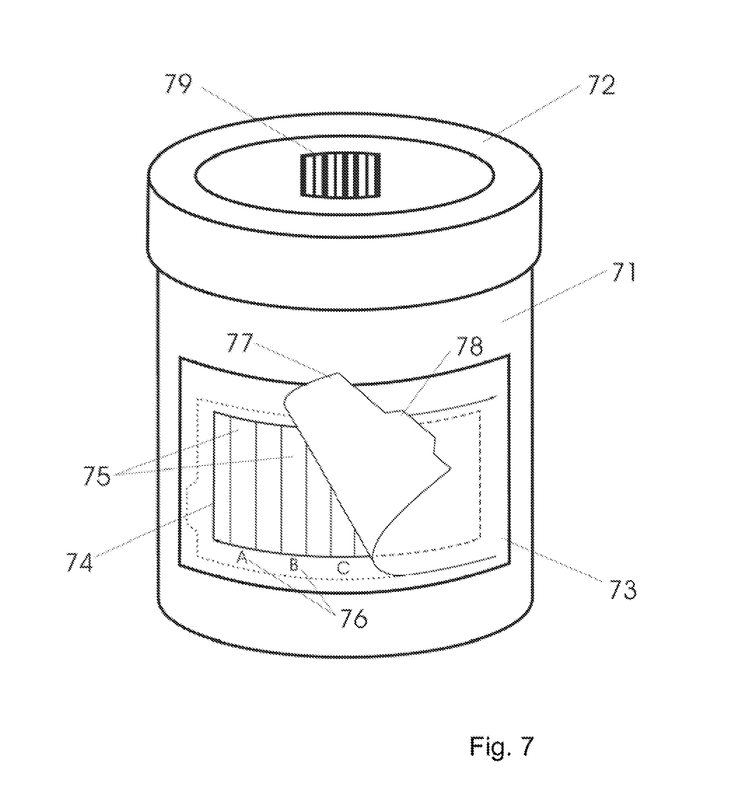

FIG. 7 shows the security drape flap being removed via the perforation to reveal the viewing window thereunder. Receiving vessel 71 containing urine sealed therein by sealing cap 72 includes a test strip array exposed to said urine. Security drape 73 which covers the viewing window 74 and consequently the test strips 75 and other coding indicia 76 is operated by pulling back its flap 77 by way of pull tab 78. An authorized technician receives the container system from a donor with the security drape intact. Thereafter, when the container is due for being read in accordance with appropriate exposure times, the drape flap is removed and the test strip elements are exposed for visual inspection. Coding indicia may be arranged on the exterior surface of the receiving vessel to better identify which test strip is associated with which drug. Since the test card is well aligned with respect to the receiving vessel and does not move about therein, then the individual test strips will be conveniently label with easy to read and identify codings. This assures that a technician does not mistake one test from another and makes the system easier to clearly read without error.

To further aid in processing functionality and privacy, it some versions the system is identified by computer readable mechanisms such as bar coding. Bar code indicia 79 may be applied to the sealing cap at its exterior top as shown. In this way, donor privacy and identity secrecy may be maintained even when test results are revealed.

The examples above are directed to specific embodiments which illustrate preferred versions of devices and methods of these inventions. In the interests of completeness, a more general description of devices and the elements of which they are comprised as well as methods and the steps of which they are comprised is presented herefollowing.

One will now fully appreciate how drug test kits including receptacles or containers for sample collection are combined with arrays of test strips to provide a comprehensive system. Although the present invention has been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

What is claimed is:

1. Biomatter sample collection kit comprising:
a receiving vessel configured for receiving the biomatter sample;
a sealing cap joined to said receiving vessel by a hinge and configured for mating with said receiving vessel to seal said receiving vessel, said hinge being configured for enabling said sealing cap to move between a decoupled mold and a coupled mold, said decoupled mold being a state in which access to an interior of said receiving vessel is afforded, and said coupled mold being a state in which said sealing cap is pushed into said receiving vessel to form a liquid tight press fit seal; and
a mechanical index located within said receiving vessel and configured for affixing a chemical test card in said receiving vessel, to form and maintain a spatial relationship between said receiving vessel and the chemical test card.

2. Biomatter sample collection s of claim 1, wherein said receiving vessel further comprises a viewing window integrated with a side wall thereof said receiving vessel.

3. Biomatter sample collection kit of claim 2, wherein said mechanical index is configured for holding the chemical test array fixed in position with respect to said viewing window.

4. (canceled)

5. (canceled)

6. (canceled)

7. (canceled)

8. Biomatter sample collection kit of claim 1, wherein said mechanical index is arranged to permit the chemical test array to be received from the receiving vessel aperture and slidably inserted therein.

9. Biomatter sample collection and test kits of claim 1, wherein said mechanical index further includes a detent arranged to prevent the test card from sliding out from said receiving vessel.

10. Biomatter sample collection kit of claim 1, wherein said sealing cap and receiving vessel are coupled via a mechanical interlock arranged as a press fit joint whereby pressure applied to the cap forces a lip on an interior surface of said cap to pass a cooperating ridge of said vessel thus forming a liquid tight seal.

11. Biomatter sample collection kit of claim 10, wherein said sealing cap and receiving vessel include cooperating translucent color bands to form an optical indicator a coupled mode is perfected.

12. Biomatter sample collection kit of claim 2, further comprising an opaque security drape affixed to the external surface of said receiving vessel over said viewing window.

13. Biomatter sample collection kit of claim 12, wherein said security drape further comprises a removable flap element whereby removal of said flap element reveals test strips of the chemical test card in the viewing window.

14. Biomatter sample collection kit of claim 13, wherein said security drape is further comprised of a perforation which couples said flap to said receiving vessel external surface, and said flap further comprises a pull tab.

15. (canceled)

16. (canceled)

17. Biomatter sample collection kit of claim 1, wherein said receiving vessel exterior surface includes indicia to distinguish and identify individual test strips of the chemical test card.

18. Biomatter sample collection and test kit, comprising:
the sample collection kit of claim 2; and
a chemical test card configured for being affixed in the receiving vessel by way of the mechanical index.

19. Biomatter sample collection and test kit of claim 18, wherein said chemical test card is arranged as a plurality of chemical reaction test strips spatially distributed about a substrate to form an array.

20. Biomatter sample collection and test kit of claim 19, wherein said chemical test card is affixed in alignment with respect to said window whereby active components thereof may be viewed through said viewing window.

21. Biomatter sample collection and test kit of claim 20, wherein said substrate has a first surface which is curved to conform to the shape of the receiving vessel and integrated window thereof.

22. Biomatter sample collection and test kit of claim 21, wherein said receiving vessel has said interior surface which includes said mechanical index integrated therewith, said mechanical index being arranged to align said test substrate with respect to said viewing window.

23. Biomatter sample collection and test kits of claim 18, further comprising a carrier system whereby said chemical test card is affixed in said receiving vessel by way of said mechanical index via the carrier as an intermediary element.

24. Biomatter sample collection and test kits of claim 23, wherein said carrier system is particularly characterized in that it has a shape complementary to the shape of a portion of the interior of the receiving vessel.
